(19) United States
(12) Patent Application Publication
(10) Pub. No.: US 2026/0353354 A1
(43) Pub. Date: Nov. 5, 2026

(54) PAGING SKIPPING

(71) Applicant: Nokia Technologies Oy, Espoo (FI)

(72) Inventors: Yan MENG, Shanghai (CN); Tao TAO, Shanghai (CN); Jian Guo LIU, Shanghai (CN)

(73) Assignee: Nokia Technologies Oy, Espoo (FI)

(21) Appl. No.: 19/487,129

(22) PCT Filed: May 25, 2023
(86) PCT No.: PCT/CN2023/096315

§ 371 Date: Nov. 24, 2025

(51) Int. Cl. H04W 68/00

(52) U.S. Cl. CPC H04W 68/005

(57) ABSTRACT

Example embodiments of the present disclosure relate to methods, devices, apparatuses and computer readable storage medium for paging skipping. In a method, a first device determines a paging skipping condition. Based on the paging skipping condition, the first device skips monitoring for at least one paging occasion.

### FIELDS

Various example embodiments of the present disclosure generally relate to the field of telecommunication and in particular, to methods, devices, apparatuses and computer readable storage medium for paging skipping.

### BACKGROUND

New radio (NR) positioning enhancements are needed for user equipment (UE) in a radio resource control (RRC) inactive (RRC_INACTIVE) state. UE positioning measurements for UEs in an RRC_INACTIVE state may be supported, which may be based on, for example, DL-Positioning Reference Signal (PRS) or both DL-PRS and synchronization signal and physical broadcast channel (PBCH) block (SSB). Network (for example, gNB) positioning measurements may also be supported for UEs in RRC INACTIVE state. Small data transmission (SDT) is agreed to be used to transmit a measurement report in an RRC inactive state. The Release-17 (Rel-17) SDT framework for inactive uplink (UL) and downlink (DL) positioning is under study in the 3rd Generation Partnership Project (3GPP).

In addition, some UEs such as Low Power High Accuracy Positioning (LPHAP) devices, Reduced capability (Redcap) UEs and ambient Internet of Things (IoT) devices may have power consumption requirements. However, the Rel-17 positioning for UEs in an RRC_INACTIVE state may not satisfy a target battery life required by such UEs.

### SUMMARY

In a first aspect of the present disclosure, there is provided a method at a first device. In the method, the first device determines a paging skipping condition. Based on the paging skipping condition, the first device skips monitoring for at least one paging occasion.

In a second aspect of the present disclosure, there is provided a method at a second device. In the method, the second device determines a paging skipping condition for a first device. Based on the paging skipping condition, the second device skips transmission on at least one paging occasion.

In a third aspect of the present disclosure, there is provided a first device. The first device comprises at least one processor; and at least one memory storing instructions that, when executed by the at least one processor, cause the first device at least to: determine a paging skipping condition; and skip monitoring for at least one paging occasion based on the paging skipping condition.

In a fourth aspect of the present disclosure, there is provided a second device. The second device comprises at least one processor; and at least one memory storing instructions that, when executed by the at least one processor, cause the second device at least to: determine a paging skipping condition for a first device; and skip transmission on at least one paging occasion based on the paging skipping condition.

In a fifth aspect of the present disclosure, there is provided a first apparatus. The first apparatus comprises means for determining a paging skipping condition; and means for skipping monitoring for at least one paging occasion based on the paging skipping condition.

In a sixth aspect of the present disclosure, there is provided a second apparatus. The second apparatus comprises means for determining a paging skipping condition for a first device; and means for skipping transmission on at least one paging occasion based on the paging skipping condition.

In a seventh aspect of the present disclosure, there is provided a computer readable medium. The computer readable medium comprises instructions stored thereon for causing an apparatus to perform at least the method according to the first or second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling diagram for an example communication process in the communication environment according to some example embodiments of the present disclosure;

FIG. 3 illustrates an example process of paging skipping in accordance with some example embodiments of the present disclosure;

FIG. 4 illustrate an example scenario of paging skipping in accordance with some example embodiments of the present disclosure;

FIG. 5 illustrates another example scenario of paging skipping in accordance with some example embodiments of the present disclosure;

FIG. 6 illustrates yet another example scenario of paging skipping in accordance with some example embodiments of the present disclosure;

FIG. 7 illustrates a flow chart of an example method of paging skipping in accordance with some example embodiments of the present disclosure;

FIG. 8 illustrates a flow chart of another example method of paging skipping in accordance with some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

In TR 38.857, it is approved that the following aspects related to the NR Positioning Enhancements in an RRC inactive state may be further studied. NR positioning for UEs in an RRC_INACTIVE state is recommended for normative work, including DL, UL, both DL and UL positioning, and UE-based and UE-assisted positioning. Both UE positioning measurements and gNB positioning measurements may be supported for UEs in an RRC_INACTIVE state. The details of how to enable the UE positioning in RRC_INACTIVE state may be further discussed during normative work. These details may include, but are not limited to the following aspects: UL reference signals for UL measurements, such as sounding reference signal (SRS) for positioning and physical random access channel (PRACH) preambles; signaling and procedures for support the assistance data delivery, DL-PRS configuration, UL reference signals for positioning resource configuration, and measurement reporting, which may be developed based on the enhancements of signaling and procedures (for example, 2-step and/or 4-step PRACH procedures, a paging procedure, SDT).

As mentioned above, SDT is agreed to be used to transmit a measurement report in an RRC inactive state. PRS measurement may be reported when the UE is in an RRC INACTIVE state (for measurements performed in an RRC idle (RRC_IDLE)/RRC_INACTIVE state). A PRS measurement report and/or a location estimate is sent from the UE in an RRC_INACTIVE state to the gNB. The use of SDT for the measurement report in the RRC_INACTIVE state is studied by 3GPP RAN2. Radio access technology (RAT) independent positioning may be supported in an RRC_IDLE/INACTIVE state.

A UL SDT waiting mechanism may be used for DL data transmission in an RRC INACTIVE state. According to this mechanism, if a UE initiates UL SDT, the network will hold DL data until an end of a waiting time window. Such a mechanism may avoid RRC state transition and paging. However, this mechanism is used for DL data transmission at the network. In this case, the UE may still need to monitor and receive the paging information at paging occasions. Monitoring for the paging information at each paging occasion for DL data reception may be undesired and unnecessary if the DL data has been transmitted. Such unnecessary paging monitoring and reception may lead to large power consumption especially for RRC_INACTIVE UEs.

For DL positioning in an RRC_INACTIVE state, uplink LCS or LPP messages may be transported in an RRC_INACTIVE state. For example, if the UE initiated data transmission using UL SDT, the network may send a DL LCS or LPP message and RRC message to the UE. In the case that a UE in an RRC inactive state happens to initiate an RRC resume procedure for UL SDT, the network may transmit the DL data to the UE in a DL medium access control (MAC) protocol data unit (PDU) along with an RRC release message (for example, a suspend indication). However, a positioning service from an LCS client may be triggered or DL positioning assistance data may arrive at any time. Thus, there may be no on-going UL SDT when the DL data arrives. Therefore, these random DL LPP messages related positioning may lead to frequent RAN paging and the UE has to wake up frequently from an RRC inactive state, which is a waste of power. This is not expected especially for LPHAP UEs, Redcap UEs, ambient IoT devices since it is against the original intention of power saving for RRC_INACTIVE positioning of these devices.

Example embodiments of the present disclosure propose a paging skipping scheme. With this scheme, based on a paging skipping condition, a device such as a UE skips monitoring for at least one paging occasion. In this way, through the paging skipping condition, unnecessary paging reception may be avoided, thereby reducing the paging activities (for example, paging transmission and reception) and effectively saving the power for the UE. This would be beneficial for lower power devices (for example, LPHAP devices, Redcap devices, and Ambient IoT devices) to reduce unnecessary power consumption.

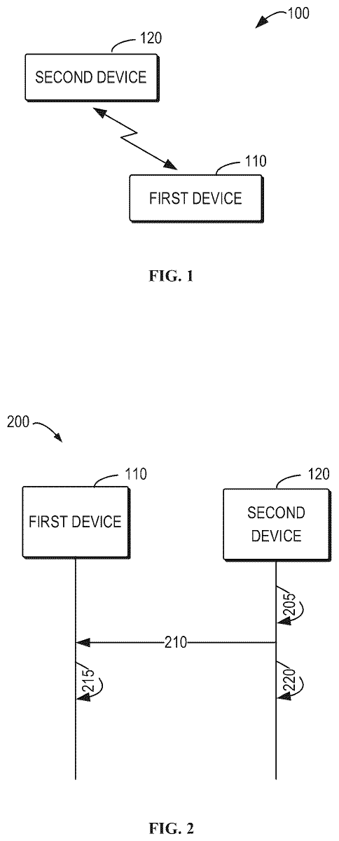

FIG. 1 illustrates an example communication environment 100 in which example embodiments of the present disclosure can be implemented. In the communication environment 100, a first device 110 and a second device 120 can communicate with each other. In some example embodiments, the first device 110 may be a terminal device, for example, an LPHAP device, a RedCap UE, and an ambient IOT device. The second device 120 may be a network device such as a gNB. In an example, the first device 110 may operate in a connected or inactive or idle state.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or another device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver). If both the first device 110 and the second device 120 are terminal devices, a link between two terminal devices is referred to as a sidelink (SL). In SL, one of the first and second devices 110 and 120 is a TX device (or a transmitter), and the other of the first and second devices 110 and 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connections shown in FIG. 1 are only for the purpose of illustration without suggesting any limitation. The communication environment 100 may include any suitable number of devices configured to implement example embodiments of the present disclosure.

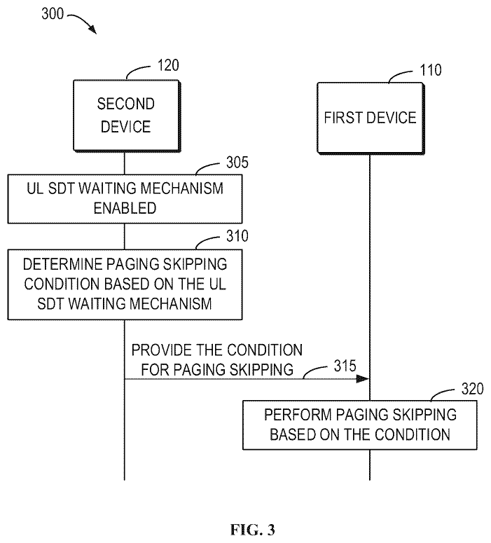

In various embodiments, a paging skipping condition is used for paging operations between the second device 120 and the first device 110. Some example implementations will be discussed below with reference to FIGS. 2 to 6.

FIG. 2 illustrates a signaling diagram for an example communication process 200 between the first device 110 and the second device 120 in the communication environment 100 according to some example embodiments of the present disclosure.

As shown in FIG. 2, the second device 120 may determine (205) a paging skipping condition for the first device 110. The paging skipping condition may also referred to as a paging transmission and reception skipping rule or a paging skipping rule.

In some example embodiments, the paging skipping condition may be determined based on an SDT waiting mechanism. In an example, in the example embodiments where the first device 110 operates as a terminal device and the second device 120 operates as a network device, the second device 120 may determine the paging skipping condition based on a following assumption associated with a UL SDT waiting mechanism. The second device 120 may wait for the UL SDT after the DL data arrives the first device 110, and the second device 120 may not page the first device 110 immediately if there is on-going UL SDT. For example, the second device 120 may not page the first device 110 at next one or more paging occasions for DL data transmission after the first device 110 has initiated UL SDT. In some example embodiments, if there is no UL SDT within one time window, the second device 120 may page the first device 110 for DL data reception at the paging occasions within the time window.

In some example embodiments, the second device 120 may not page the first device 110 at next one or more paging occasions after the second device 120 has initiated paging for the first 110, for example, for data transmission. As such, frequent paging transmission and reception of the first and second devices 110 and 120 may be avoided, thereby reducing power consumption.

In some example embodiments, some parameters such as a timer and a time window may be used for paging skipping. In an example, the paging skipping condition may comprise a condition that at least one paging occasion is skipped during running of a first timer, and the first timer is started or restarted after the first device 110 initiates SDT to the second device 120 and/or after the second device 120 initiates paging for the first device 110. In some example embodiments, such a condition may indicate that the second device 120 may not page the first device 110 for the next one or more paging occasions even if there is data arrivals after the first timer is started and during the running of the first timer.

In some example embodiments, the first timer may be expired after the first number of skipped paging occasions (for example, continuous paging occasions), which is greater than or equal to a first threshold number. For example, the first threshold number may be a threshold for the maximum number of continuous paging occasion that may be skipped. Alternatively, or in addition, the first timer may be expired after a first time window. The paging operation may be continued after the first timer is expired. For example, after the first timer is expired, the second device 120 may paging the first device 110 at a paging occasion if the second device 120 has arrived data.

In some example embodiments, the paging skipping condition may comprise a condition that at least one paging occasion is skipped during running of a second timer, and the second timer is started or restarted after the second device 120 initiates the paging for the first device 110. The second timer is expired after a second number of skipped paging occasions, which is equal to or greater than a second threshold number, and/or after a second time window. In some example embodiments, such a condition may indicate that the second device 120 may continue to page the first device 110 for the next one paging occasion after the second timer is expired.

In some example embodiments, the first threshold number, the second threshold number, the first time window, and/or the second time window may be determined by the second device 120 based on the QoS information of DL data. In some example embodiments, the first threshold number and/or the first window may be determined based on a delay requirement of transmission to the first device 110. For example, if the delay requirement is stricter, the first threshold number may be set to be smaller, and/or the first time window may be shorter, to reduce transmission delay caused by paging skipping. If the delay requirement is much less strict, the first threshold number may be larger, or the first time window may be longer.

In some example embodiments, the second threshold number and/or the second time window may be determined based on a requirement of system information update. For example, if some system information needs to be updated more frequently, the second threshold number may be set to be smaller, and/or the second time window may be shorter; and vice versa. As such, update delay may be reduced.

In some example embodiments, as shown in FIG. 2, the second device 120 may transmit (210) a configuration of the paging skipping condition to the first device 110. Accordingly, the first device may receive the configuration of the paging skipping condition from the second device 120. In some example embodiments, the configuration of the paging skipping condition may be transmitted from the second device 120 to the first device 110 via RRC signaling before the first device 110 enters an inactive state, for example, an RRC_INACTIVE state.

In some example embodiments, the configuration of the paging skipping condition may indicate the condition(s) itself and the related parameter(s) such as the first threshold number, the first time period, the second threshold number, and/or the second time window. Based on such an indication of the paging skipping condition from the second device 120, the first device 110 may know when and how to skip the paging monitoring and reception.

In some example embodiments, the paging skipping condition may be predefined or specified. In this case, the first device 110 and the second device 120 may determine the paging skipping condition to be used by themselves. There may be no need for transmission (210) of a configuration of the paging skipping condition from the second device 120 to the first device 110.

Based on the paging skipping condition, the first device 110 may skip (215) monitoring for at least one paging occasion. For example, the first device 110 may enable the skipping after the first timer is started or restarted and/or continue to monitor for a paging occasion after the first or second timer is expired. Accordingly, the second device 120 may skip (220) transmission on at least one paging occasion based on the paging skipping condition.

By way of example, based on the paging skipping condition, the second device 120 may not page the first device 110 for the next one or more paging occasions after the first device 110 has initiated the UL SDT or after the second device 120 has initiated paging for the first device 110 (for example, for data transmission). In this case, the first timer may be started after the first device 110 has initiated the UL SDT or after the second device 120 has initiated paging for the first device 110. The second timer may also be started after the second device 120 has initiated the paging. After the first timer is started, the first device 110 may skip the next one or more paging occasions. After the first or second timer is expired, the first device 110 may continue to monitor for a next paging occasion. In this case, the second device 120 may use legacy paging transmission, and the first device 110 may start to receive paging information at a paging occasion.

In some example embodiments, the first device may be in an inactive state such as an RRC INACTIVE state. In this case, the frequent wake up of the device caused by frequent paging may be reduced, thereby reducing the waste of power.

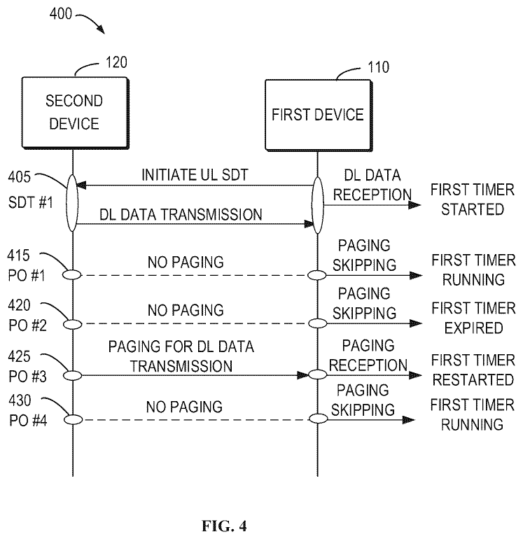

FIG. 3 shows an example process 300 of paging skipping in accordance with some example embodiments of the present disclosure. In this example, the second device 120 may operate as a network device, and the first device 110 may operate as a terminal device.

As shown in FIG. 3, in the process 300, at 305, an UL SDT waiting mechanism may be enabled at the second device 120. At 310, the second device 120 may determine a paging skipping condition based on the UL SDT waiting mechanism. At 315, the second device 120 may provide the paging skipping condition to the first device 110. At 320, the first device 110 may perform paging skipping based on the paging skipping condition.

Some example processes of paging skipping will be described below with reference to FIGS. 4 to 6 which illustrate three example scenarios where UL SDT or no UL SDT appears before the first or second timer is expired. In these scenarios, the second device 120 may operate as a network device, and the first device 110 may operate as a terminal device.

Reference is first made to FIG. 4 which illustrates an example process 400 of paging skipping in accordance with some example embodiments of the present disclosure. In this process, there may be no UL SDT appearing before the first timer is expired. It is assumed that the maximum number of continuous paging occasions that can be skipped (as an example of the first threshold number) is 2 in this example.

As shown in FIG. 4, in the process 400, at a SDT occasion 405, labeled as SDT #1, when the first device 110 has initiated UL SDT to the second device 120, the first timer is started. After the first timer is started, at paging occasions (POs) 415 and 420, labeled as PO #1 and PO #2, the second device 120 may not page the first device 110 at the next two paging occasions. At this time, since the number of continuous skipped paging occasions is 2, which is equal to the first threshold number, the first timer is expired. Therefore, the second device 120 may page the first device 110 at a PO 425, labeled as PO #3, for DL data transmission. Correspondingly, the first device 110 may monitor the paging information at PO #3 for DL data reception when the first timer is expired. As shown in FIG. 4, the first timer may be restarted, when the second device 120 has initiated paging for DL data transmission at PO #3. After the first device 110 receives the DL data, the second device 120 and the first device 110 may continue to perform the paging skipping at a next paging occasion 430 (labeled as PO #4).

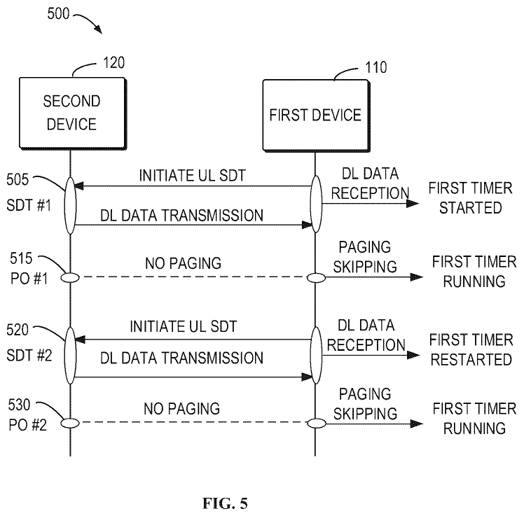

FIG. 5 illustrates an example process 500 of paging skipping in accordance with some example embodiments of the present disclosure. In this process, there may be UL SDT appearing before the first timer is expired. It is assumed that the maximum number of continuous paging occasions that can be skipped (as an example of the first threshold number) is 2 in this example.

As shown in FIG. 5, in the process 500, there is one UL SDT occasion 520 (labeled as SDT #2) when the first timer is still running. At a SDT occasion 505, labeled as SDT #1, the first device 110 has initiated UL SDT to the second device 120, and the second device 120 transmits DL data to the first device 110. At this time, the first timer is started. The second device 120 and the first device 110 skip a paging occasion 515, labeled as PO #1. At the SDT occasion 520 (or SDT #2), the UL SDT appears. In this case, the first timer is restarted. The second device 120 and the first device 110 may continue to skip the paging transmission and reception at a paging occasion 530, labeled as PO #2.

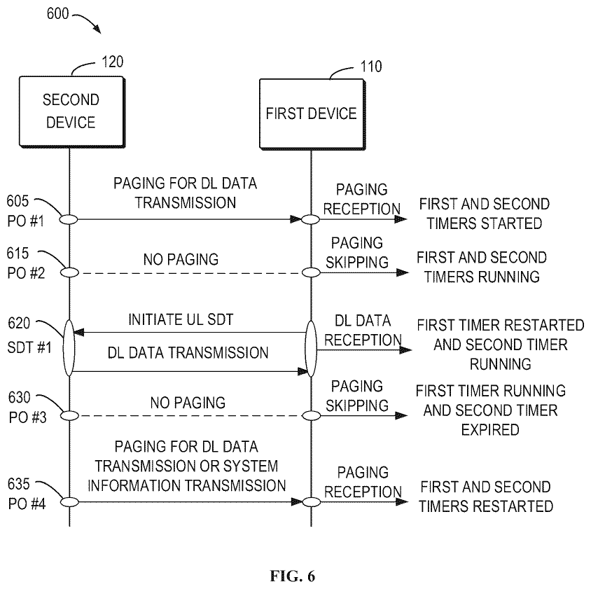

In this case, there may be a situation that the second device 120 may not page the first device 110 for a long time if UL SDT always appears before the first timer is expired. Thus, the first device 110 may not receive system information from the second device 120 through paging for a long time, which may cause longer delay of the system information update. The second timer may be used to reduce such delay as will be discussed below with reference to FIG. 6.

FIG. 6 illustrates an example process 600 of paging skipping in accordance with some example embodiments of the present disclosure. In this process, there may be UL SDT appears before the first timer is expired. It is assumed that the maximum number of continuous paging occasions that can be skipped (as an example of the first and second threshold numbers) is 2 in this example.

Similar to the process 500, as shown in FIG. 6, in the process 600, there is one UL SDT occasion 620 (labeled as SDT #1) when the first timer is still running. At a paging occasion 605 (labeled as PO #1), the second device 120 pages the first device 110 for DL data transmission. At this time, both the first and second timers are started. The second device 120 and the first device 110 skip one paging occasion 615, labeled as PO #2. At the SDT occasion 620 (or SDT #1), the UL SDT appears. In this case, the first timer is restarted. The second device 120 and the first device 110 may continue to skip the paging transmission and reception at a paging occasion 630 (labeled as PO #3). At this time, the number of continuous skipped paging occasions is 2, which is equal to the second threshold number. Thus, the second timer is expired. Then, at a PO 635 (labeled as PO #4), the second device 120 may page the first device 110 for DL data transmission or system information transmission. Accordingly, the first device 110 may perform the paging reception at PO #4. In this case, both the first and second timers are restarted.

Due to the occurrence of UL SDT, the second device 120 may always not page the first device 110 if UL SDT always appears before the first timer is expired, and the first device 110 may not receive system information from the second device 120 through paging for a long time. By using the second timer, the second device 120 may page the first device 110 when several paging occasions have been skipped. For example, if the number of paging skipping is larger than the second threshold number, the second device 120 may continue the paging. As such, transmission delay may be reduced.

### Example Methods

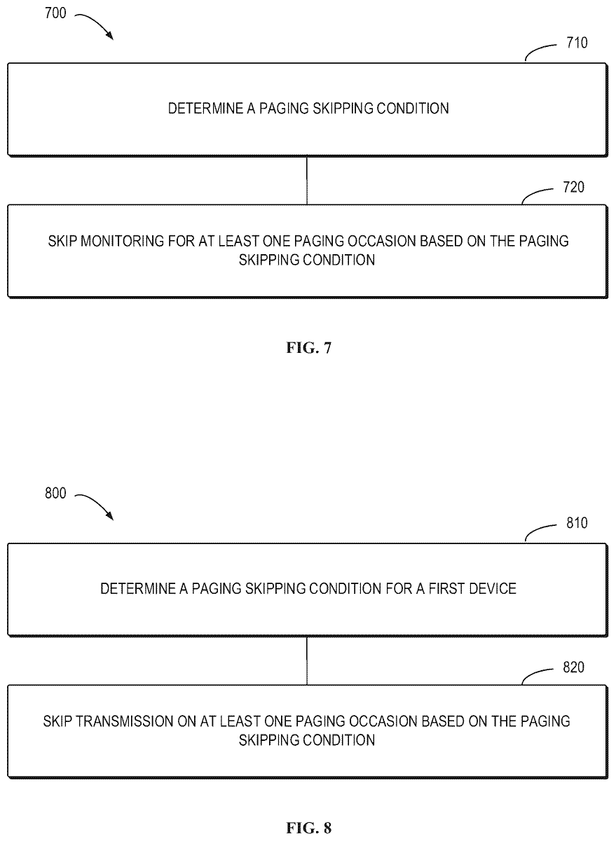

FIG. 7 shows a flowchart of an example method 700 implemented at a first device in accordance with some example embodiments of the present disclosure. The method 700 may be implemented at the first device 110. For the purpose of discussion, the method 700 will be described from the perspective of the first device 110 with reference to FIG. 1.

At block 710, the first device 110 determines a paging skipping condition. At block 720, the first device 110 skips monitoring for at least one paging occasion based on the paging skipping condition.

In some example embodiments, the paging skipping condition may comprise a condition that at least one paging occasion is skipped during running of a first timer. The first timer may be started or restarted after the first device 110 initiates SDT to the second device 120 and/or after the second device 120 initiates paging for the first device. The skipping may be enabled after the first timer is started or restarted.

In some example embodiments, the first timer may be expired after at least one of: a first number of skipped paging occasions, the first number being equal to or greater than a first threshold number, or a first time window.

In some example embodiments, the paging skipping condition may comprise a condition that at least one paging occasion is skipped during running of a second timer. The second timer is started or restarted after the second device 120 initiates the paging for the first device 110.

In some example embodiments, the second timer may be expired after at least one of: a second number of skipped paging occasions, the second number being equal to or greater than a second threshold number, or a second time window.

In some example embodiments, the first device 110 may monitor for a paging occasion after the first or second timer is expired.

In some example embodiments, t the first device 110 may receive, from a second device, a configuration of the paging skipping condition.

In some example embodiments, the configuration of the paging skipping condition may comprise at least one of the first or second threshold number or the first or second time window.

In some example embodiments, the configuration of the paging skipping condition may be received via RRC signaling.

In some example embodiments, the configuration of the paging skipping condition may be received before the first device 110 enters an inactive state.

In some example embodiments, the first device 110 may be in an inactive state.

FIG. 8 shows a flowchart of an example method 800 implemented at a second device in accordance with some example embodiments of the present disclosure. The method 800 may be implemented at the second device 120. For the purpose of discussion, the method 800 will be described from the perspective of the second device 120 with reference to FIG. 1.

At block 810, the second device 120 determines a paging skipping condition for a first device. At block 820, the second device 120 skips transmission on at least one paging occasion based on the paging skipping condition.

In some example embodiments, the paging skipping condition may comprise a condition that at least one paging occasion is skipped during running of a first timer. The first timer may be started or restarted after the first device 110 initiates SDT to the second device 120 and/or after the second device 120 initiates paging for the first device. The skipping may be enabled after the first timer is started or restarted.

In some example embodiments, the first timer may be expired after at least one of: a first number of skipped paging occasions, the first number being equal to or greater than a first threshold number, or a first time window.

In some example embodiments, the paging skipping condition may comprise a condition that at least one paging occasion is skipped during running of a second timer. The second timer is started or restarted after the second device 120 initiates the paging for the first device 110.

In some example embodiments, the second timer may be expired after at least one of: a second number of skipped paging occasions, the second number being equal to or greater than a second threshold number, or a second time window.

In some example embodiments, the second device 120 may initiate paging transmission for the first device 110 at a paging occasion after the first or second timer is expired.

In some example embodiments, the second device 120 may transmit, to the first device 110, a configuration of the paging skipping condition.

In some example embodiments, the configuration of the paging skipping condition may comprise at least one of the first or second threshold number or the first or second time window.

In some example embodiments, the second device 120 may determine at least one of the first threshold number or the first time window based on a delay requirement of transmission to the first device.

In some example embodiments, the second device 120 may determine at least one of the second threshold number or the second time window based on a requirement of system information update.

In some example embodiments, the configuration of the paging skipping condition may be transmitted via RRC signaling.

In some example embodiments, the configuration of the paging skipping condition may be transmitted before the first device 110 enters an inactive state.

All operations and features related to the first device 110 and the second device 120 as described above with reference to FIGS. 1 to 6 are likewise applicable to the methods 700 and 800 and have similar effects. For the purpose of simplification, the details will be omitted.

### Example Apparatus, Device and Medium

In some example embodiments, a first apparatus capable of performing the method 700 (for example, the first device 110 in FIG. 1) may comprise means for performing the respective operations of the method 700. The means may be implemented in any suitable form. For example, the means may be implemented in a circuitry or software module. The first apparatus may be implemented as or included in the first device 110 in FIG. 1.

In some example embodiments, the first apparatus comprises means for determining a paging skipping condition; and means for skipping monitoring for at least one paging occasion based on the paging skipping condition.

In some example embodiments, the paging skipping condition comprises a condition that at least one paging occasion is skipped during running of a first timer, wherein the first timer is started or restarted after the first device initiates small data transmission to the second device and/or after the second device initiates paging for the first device, and the skipping is enabled after the first timer is started or restarted.

In some example embodiments, the first timer is expired after at least one of: a first number of skipped paging occasions, the first number being equal to or greater than a first threshold number, or a first time window.

In some example embodiments, the paging skipping condition comprises a condition that at least one paging occasion is skipped during running of a second timer, wherein the second timer is started or restarted after the second device initiates the paging for the first device.

In some example embodiments, the second timer is expired after at least one of: a second number of skipped paging occasions, the second number being equal to or greater than a second threshold number, or a second time window.

In some example embodiments, the first apparatus further comprises means for monitoring for a paging occasion after the first or second timer is expired.

In some example embodiments, the first apparatus further comprises means for receiving, from a second device, a configuration of the paging skipping condition.

In some example embodiments, the configuration of the paging skipping condition comprises at least one of the first or second threshold number or the first or second time window.

In some example embodiments, the configuration of the paging skipping condition is received via radio resource control signaling.

In some example embodiments, the configuration of the paging skipping condition is received before the first device enters an inactive state.

In some example embodiments, the first apparatus is in an inactive state.

In some example embodiments, the first apparatus further comprises means for performing other operations in some example embodiments of the method 700 or the first device 110. In some example embodiments, the means comprises at least one processor; and at least one memory storing instructions that, when executed by the at least one processor, cause the performance of the first apparatus.

In some example embodiments, a second apparatus capable of performing the method 800 (for example, the second device 120 in FIG. 1) may comprise means for performing the respective operations of the method 800. The means may be implemented in any suitable form. For example, the means may be implemented in a circuitry or software module. The second apparatus may be implemented as or included in the second device 120 in FIG. 1.

In some example embodiments, the second apparatus comprises means for determining a paging skipping condition for a first device; and means for skipping transmission on at least one paging occasion based on the paging skipping condition.

In some example embodiments, the paging skipping condition comprises a condition that at least one paging occasion is skipped during running of a first timer, wherein the first timer is started or restarted after the first device initiates small data transmission to the second device and/or after the second device initiates paging for the first device, and the skipping transmission is enabled after the first timer is started or restarted.

In some example embodiments, the first timer is expired after at least one of: a first number of skipped paging occasions, the first number being equal to or greater than a first threshold number, or a first time window.

In some example embodiments, the paging skipping condition comprises a condition that at least one paging occasion is skipped during running of a second timer, wherein the second timer is started or restarted after the second device initiates the paging for the first device.

In some example embodiments, the second timer is expired after at least one of: a second number of skipped paging occasions, the second number being equal to or greater than a second threshold number, or a second time window.

In some example embodiments, the second apparatus further comprises means for initiating paging transmission for the first device at a paging occasion after the first or second timer is expired.

In some example embodiments, the second apparatus further comprises means for transmitting, to the first device, a configuration of the paging skipping condition.

In some example embodiments, the configuration of the paging skipping condition comprises at least one of the first or second threshold number or the first or second time window.

In some example embodiments, the second apparatus further comprises means for determining at least one of the first threshold number or the first time window based on a delay requirement of transmission to the first device.

In some example embodiments, the second apparatus further comprises means for determining at least one of the second threshold number or the second time window based on a requirement of system information update.

In some example embodiments, the configuration of the paging skipping condition is transmitted via radio resource control signaling.

In some example embodiments, the configuration of the paging skipping condition is transmitted before the first device enters an inactive state.

In some example embodiments, the first device is in an inactive state.

In some example embodiments, the second apparatus further comprises means for performing other operations in some example embodiments of the method 800 or the second device 120. In some example embodiments, the means comprises at least one processor; and at least one memory storing instructions that, when executed by the at least one processor, cause the performance of the second apparatus.

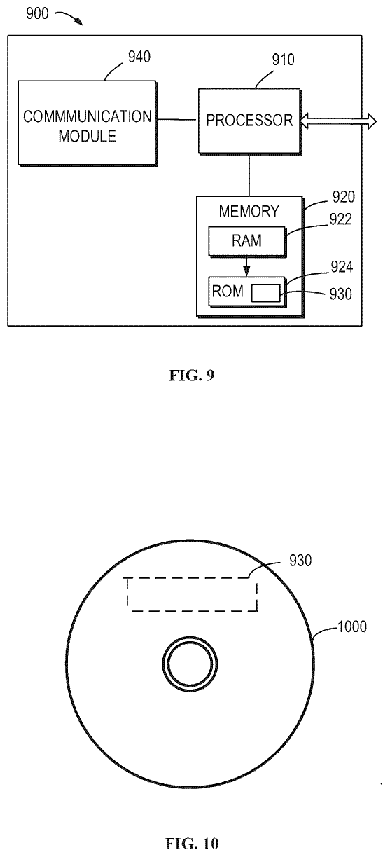

FIG. 9 is a simplified block diagram of a device 900 that is suitable for implementing example embodiments of the present disclosure. The device 900 may be provided to implement a communication device, for example, the first device 110 or the second device 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 1 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method comprising:
at a first device,
determining a paging skipping condition; and
skipping monitoring for at least one paging occasion based on the paging skipping condition.

2. The method of claim 1, wherein the paging skipping condition comprises a condition that at least one paging occasion is skipped during running of a first timer, wherein the first timer is started or restarted after the first device initiates small data transmission to the second device and/or after the second device initiates paging for the first device, and the skipping is enabled after the first timer is started or restarted.

3. The method of claim 2, wherein the first timer is expired after at least one of:
a first number of skipped paging occasions, the first number being equal to or greater than a first threshold number, or
a first time window.

4. The method of claim 2, wherein the paging skipping condition comprises a condition that at least one paging occasion is skipped during running of a second timer, wherein the second timer is started or restarted after the second device initiates the paging for the first device.

5. The method of claim 4, wherein the second timer is expired after at least one of:
a second number of skipped paging occasions, the second number being equal to or greater than a second threshold number, or
a second time window.

6. The method of any of claim 2, further comprising:
monitoring for a paging occasion after the first or second timer is expired.

7. The method of claim 4, further comprising:
receiving, from a second device, a configuration of the paging skipping condition.

8. The method of claim 7, wherein the configuration of the paging skipping condition comprises at least one of the first or second threshold number or the first or second time window.

9-11. (canceled)

12. A second device comprising:
at least one processor; and
at least one memory storing instructions that, when executed by the at least one processor, cause the second device at least to perform:
determining a paging skipping condition for a first device; and
skipping transmission on at least one paging occasion based on the paging skipping condition.

13-29. (canceled)

30. A first device comprising:
at least one processor; and
at least one memory storing instructions that, when executed by the at least one processor, cause the first device at least to perform:
determining a paging skipping condition; and
skipping monitoring for at least one paging occasion based on the paging skipping condition.

31. The first device of claim 30, wherein the paging skipping condition comprises a condition that at least one paging occasion is skipped during running of a first timer, wherein the first timer is started or restarted after the first device initiates small data transmission to the second device and/or after the second device initiates paging for the first device, and the skipping is enabled after the first timer is started or restarted.

32. The first device of claim 31, wherein the first timer is expired after at least one of:
a first number of skipped paging occasions, the first number being equal to or greater than a first threshold number, or
a first time window.

33. The first device of claim 31, wherein the paging skipping condition comprises a condition that at least one paging occasion is skipped during running of a second timer, wherein the second timer is started or restarted after the second device initiates the paging for the first device.

34. The first device of claim 33, wherein the second timer is expired after at least one of:
a second number of skipped paging occasions, the second number being equal to or greater than a second threshold number, or
a second time window.

35. The first device of claim 31, further comprising:
monitoring for a paging occasion after the first or second timer is expired.

36. The first device of claim 33, further comprising:
receiving, from a second device, a configuration of the paging skipping condition.

37. The first device of claim 36, wherein the configuration of the paging skipping condition comprises at least one of the first or second threshold number or the first or second time window.

38. The first device of claim 36, wherein the configuration of the paging skipping condition is received via radio resource control signaling.

39. The first device of claim 36, wherein the configuration of the paging skipping condition is received before the first device enters an inactive state.

40. The first device of claim 30, wherein the first device is in an inactive state.
